(19) United States
(12) Patent Application Publication
(10) Pub. No.: US 2022/0308688 A1
(43) Pub. Date: Sep. 29, 2022

(54) CAPACITIVE STYLUS PEN

(71) Applicant: SHENZHEN SUNWAY COMMUNICATION CO., LTD., Shenzhen (CN)

(72) Inventors: Xingjun ZHAO, Shenzhen (CN); Song FU, Shenzhen (CN)

(73) Assignee: SHENZHEN SUNWAY COMMUNICATION CO., LTD., Shenzhen (CN)

(21) Appl. No.: 17/466,169

(22) Filed: Sep. 3, 2021

Related U.S. Application Data
(63) Continuation of application No. PCT/CN2021/110172, filed on Aug. 3, 2021.

(30) Foreign Application Priority Data
Mar. 26, 2021 (CN) 202110325839.2
Mar. 26, 2021 (CN) 202110327378.2
Mar. 29, 2021 (CN) 202110334957.X
Mar. 30, 2021 (CN) 202110338966.6

(51) Int. Cl. G06F 3/0354; G06F 3/044

(52) U.S. Cl. CPC G06F 3/03546; G06F 3/0442

(57) ABSTRACT

Disclosed a capacitive stylus pen, comprising a holding structure comprising a pen holder, and a pen tip assembly comprising a pen tip shaft and a strain sensor, the strain sensor comprising a resilient element and a strain gauge on the resilient element, and the resilient element being connected to the pen tip shaft and the holding structure, wherein the resilient element is L-shaped, the pen tip assembly further comprises an energy absorption structure arranged on the pen tip shaft, and the energy absorption structure is connected to the holding structure. The L-shaped resilient element in cooperation with the energy absorption structure forms a double-support elastic buffering structure and reduces deformation rate of the strain gauge with same load when the capacitive stylus pen itself rotates to different angles; and the energy absorption structure is added to share part of the stress on the resilient element to reduce the resilient element's deformation.

### CROSS-REFERENCE TO RELATED APPLICATIONS

The present application is a continuation of International Application No. PCT/CN2021/110172 filed on Aug. 3, 2021, which claims priority to Chinese Patent Applications No. 202110325839.2 filed on Mar. 26, 2021, No. 202110327378.2 filed on Mar. 26, 2021, No. 202110334957.X filed on Mar. 29, 2021 and No. 202110338966.6 filed on Mar. 30, 2021. All applications are incorporated herein by reference in their entireties.

### TECHNICAL FIELD

The preset application relates to the technical field of touch control devices, and in particular, to a capacitive stylus pen.

### BACKGROUND ART

With the increasing popularity of capacitive screens, more and more electronic products such as tablet computers, mobile phones, and navigators have begun to use capacitive screens for operation and control. Although the capacitive screen can be touched with a finger, it is easy to stain the display because of the dirt of the finger, and the touch precision of the fingers is not good too, while some professionals cannot reach the required precision by the fingers, so more and more consumers are pursuing high-quality capacitive stylus pens to operate the touch screen. The conventional capacitive stylus pen generally comprises a pen holder, and a pen tip assembly, a battery, an antenna, a main control board, etc arranged in the pen holder, wherein the pen tip assembly comprises a pen tip shaft, and a strain sensor and an electrode assembly which are arranged on the pen tip shaft, the strain sensor comprises a resilient element and a strain gauge on the resilient element, and the resilient element is generally a double-arm support structure (such as a U-shaped structure). When the pen tip is stressed, the stress is transmitted to the strain sensor, two arms of the strain sensor are stressed and deformed, and the strain gauge is arranged on one of the arms, and its deformation outputs an electric signal.

The U-shaped resilient element can effectively solve the problem of large difference in relationships between different writing angles, loads and strain gauge deformation, and in order to avoid the patents of other manufactures, the applicant proposes a capacitive stylus pen with a new structure.

### SUMMARY OF THE INVENTION

A technical problem to be solved in the present application is to provide a capacitive stylus pen with a novel structure.

In order to solve the technical problem, the following technical scheme is adopted: a capacitive stylus pen, comprising a holding structure comprising a pen holder, and a pen tip assembly comprising a pen tip shaft and a strain sensor, the strain sensor comprising a resilient element and a strain gauge on the resilient element, and the resilient element being connected to the pen tip shaft and the holding structure, wherein the resilient element is L-shaped, the pen tip assembly further comprises an energy absorption structure arranged on the pen tip shaft, and the energy absorption structure is connected to the holding structure.

The present application has the following beneficial effects: in the capacitive stylus pen, the L-shaped resilient element in cooperation with the energy absorption structure forms a double-support elastic buffering structure, which is novel and practical, and enables the capacitive stylus pen to rotate to different angles and also reduces deformation rate of the strain gauge with the same load, so that the signal output consistency is excellent, achieving the same use effect and experience as a U-shaped resilient element; compared with a single-arm resilient element, the energy absorption structure is added to share part of the stress on the resilient element so as to reduce the deformation of the resilient element, thereby prolonging the service life of the resilient element; in addition, under the conditions of different writing angles and inclination angles, the capacitive stylus pen has a good strain linearity, and has a great advantage in future selection for chip design.

### BRIEF DESCRIPTION OF THE DRAWINGS

FIG. 1 is a schematic diagram showing the overall structure of a capacitive stylus pen of the present application;

FIG. 2 is a schematic diagram illustrating the structure of the capacitive stylus pen of the present application (with the pen holder not shown);

FIG. 3 is a schematic diagram illustrating the structure of the capacitive stylus pen of the present application (with part of the pen support and the pen holder now shown);

FIG. 4 is a schematic diagram showing the structure of a pen tip assembly of a capacitive stylus pen according to Embodiment 1 of the present application;

FIG. 5 is an exploded view of the pen tip assembly of the capacitive stylus pen according to Embodiment 1 of the present application;

FIG. 6 is a schematic diagram illustrating the structure of a strain sensor of the capacitive stylus pen according to Embodiment 1 of the present application;

FIG. 7 is a cross-sectional view of a bushing assembly of the capacitive stylus pen according to Embodiment 1 of the present application;

FIG. 8 shows a capacitive stylus pen in the prior art in a state where the pen holder is tilted at 45° with 0° self-rotation;

FIG. 9 shows a capacitive stylus pen in the prior art in a state where the pen holder is tilted at 45° with 45° self-rotation;

FIG. 10 shows a capacitive stylus pen in the prior art in a state where the pen holder is tilted at 45° with 90° self-rotation;

FIG. 11 shows a capacitive stylus pen in the prior art in a state where the pen holder is tilted at 45° with 135° self-rotation;

FIG. 12 shows a capacitive stylus pen in the prior art in a state where the pen holder is tilted at 45° with 180° self-rotation;

FIG. 13 shows the capacitive stylus pen according to Embodiment 1 of the present application in a state where the pen holder is tilted at 45° with 0° self-rotation;

FIG. 14 shows the capacitive stylus pen according to Embodiment 1 of the present application in a state where the pen holder is tilted at 45° with 45° self-rotation;

FIG. 15 shows the capacitive stylus pen according to Embodiment 1 of the present application in a state where the pen holder is tilted at 45° with 90° self-rotation;

FIG. 16 shows the capacitive stylus pen according to Embodiment 1 of the present application in a state where the pen holder is tilted at 45° with 135° self-rotation;

FIG. 17 shows the capacitive stylus pen according to Embodiment 1 of the present application in a state where the pen holder is tilted at 45° with 180° self-rotation;

FIG. 18 is a schematic diagram showing the structure of a pen tip assembly of a capacitive stylus pen according to Embodiment 2 of the present application;

FIG. 19 is a cross-sectional view of a bushing assembly of the capacitive stylus pen according to Embodiment 2 of the present application;

FIG. 20 is a schematic diagram showing the structure of a pen tip assembly of a capacitive stylus pen according to Embodiment 3 of the present application;

FIG. 21 is a top view of a resilient support of the capacitive stylus pen according to Embodiment 3 of the present application; and

FIG. 22 is an exploded view of a pen tip assembly of a capacitive stylus pen according to Embodiment 4 of the present application.

Reference Signs:
1, pen holder;
2, pen tip assembly; 21, pen tip shaft; 211, flat plate part; 2111, limiting rib; 212, threaded section; 213, abutting step; 214, mounting column; 215, mounting part; 2151, mounting plate portion; 2152, post; 22, electrode assembly; 23, strain sensor; 231, resilient element; 2311, first arm; 2312, second arm; 232, strain gauge; 24, bushing assembly; 241, inner bushing; 242, outer bushing; 2421, annular portion; 2422, extended portion; 243, inner curved surface; 244, outer curved surface; 245 chamfer structure; 25, connecting press piece; 26, pen tip locking piece; 27, resilient support; 271, fixing portion; 272, elastic branch portion; 2721, first moment arm; 2722, tilt moment arm; 2723, second moment arm; 273, reinforcing spoke;
3, chip module;
4, main control board; 41, wireless charging module;
5, battery;
6, antenna module;
7. pen support; 71, window;
8, shielding assembly;
91, resilient element;
92, fixing piece; 921, fixing plate; 922, limiting structure.

### DETAILED DESCRIPTION OF THE INVENTION

In order to describe in detail the technical content, the achieved objectives and effects of the present application, the following description will be given in conjunction with the embodiments and the accompanying drawings.

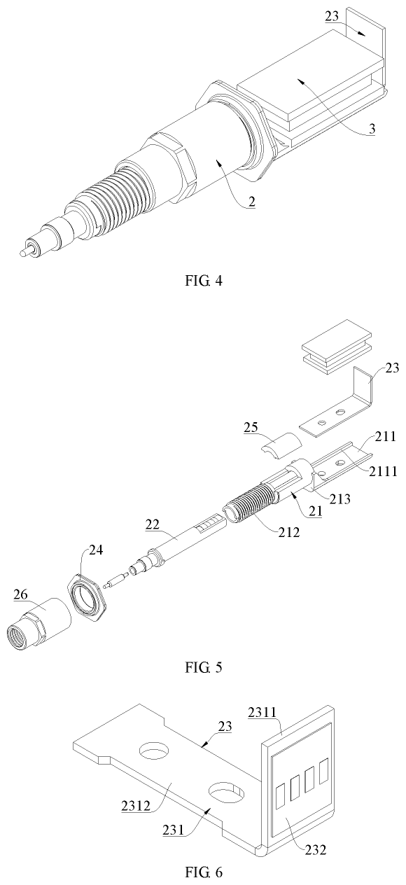

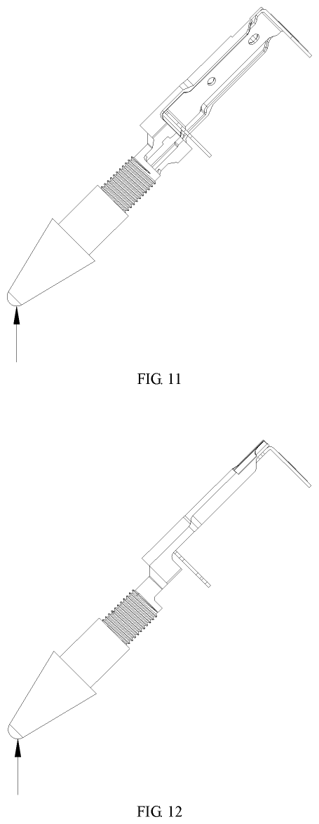

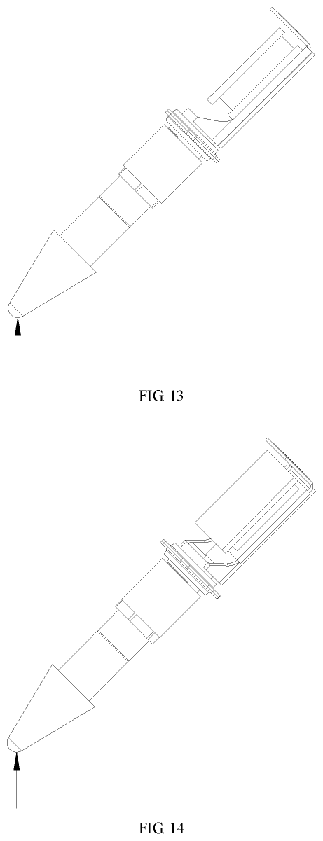

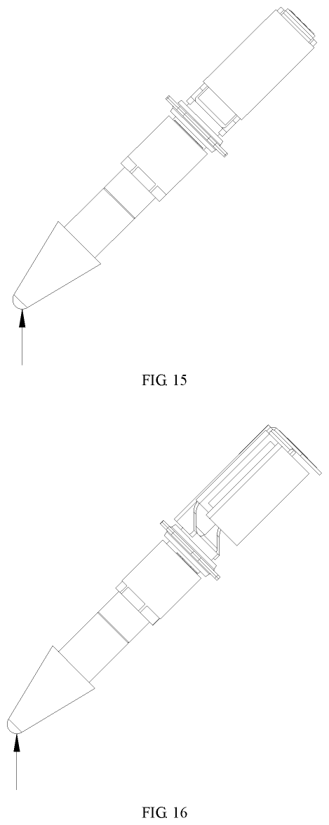

Referring to FIGS. 1 to 22, a capacitive stylus pen comprises a holding structure comprising a pen holder, and a pen tip assembly comprising a pen tip shaft and a strain sensor, the strain sensor comprising a resilient element and a strain gauge on the resilient element, and the resilient element being connected to the pen tip shaft and the holding structure, wherein the resilient element is L-shaped and further comprises an energy absorption structure arranged on the pen tip shaft, and the energy absorption structure is connected to the holding structure.

As can be seen from the above description, the invention has the beneficial effects: in the capacitive stylus pen, the L-shaped resilient element in cooperation with the energy absorption structure forms a double-support elastic buffering structure, which is novel and practical, and enables the capacitive stylus pen to rotate to different angles and also reduces deformation rate of the strain gauge with the same load, so that the signal output consistency is excellent, achieving the same use effect and experience as a U-shaped resilient element; compared with a single-arm resilient element, the energy absorption structure is added to share part of the stress on the resilient element so as to reduce the deformation of the resilient element, thereby prolonging the service life of the resilient element; in addition, under the conditions of different writing angles and inclination angles, the capacitive stylus pen has a good strain linearity, and has a great advantage in future selection for chip design.

In a specific embodiment, the resilient element comprises a first arm and a second arm which are connected, the first arm is connected and fixed to the holding structure, the second arm is fixed to the pen tip shaft, and the strain gauge is arranged on the first arm.

As can be seen from the above description, the strain sensor is simple in structure, easy to manufacture and low in production cost.

In a specific embodiment, the pen tip shaft comprises a flat plate part, the second arm is fixed on the flat plate part, and the flat plate part is provided with limiting ribs for limiting the position of the second arm.

As can be seen from the above description, the limiting ribs are provided to limit the position of the second arm, so that the assembly of the resilient element and the pen tip shaft is facilitated, and the product consistency is improved; in addition, the limiting ribs can also protect the second arm, and prevent the second arm from being accidentally scratched during assembly.

In a specific embodiment, the pen tip assembly further comprises a chip module electrically connected to the strain sensor, and the chip module is arranged on the limiting ribs.

As can be seen from the above description, the limiting ribs not only limit and protect the second arm, but also provides a mounting position for the chip module, so that multiple purposes are achieved by one component, which makes the structure of the pen tip assembly more compact, and leaves sufficient space for mounting other components of the capacitive stylus pen.

In a specific embodiment, the energy absorption structure is arranged far away from the strain gauge.

As can be seen from the above description, the energy absorption structure is arranged far away from the strain gauge to better share the stress of the resilient element and reduce the deformation of the resilient element, so that the resilient element is more durable.

In a specific embodiment, the holding structure further comprises a pen support arranged in the pen holder and/or a shielding assembly arranged in the pen holder.

As can be seen from the above description, the energy absorption structure may be mounted at various positions according to the needs, which is beneficial to enrich the diversity of the capacitive stylus pen.

In a specific embodiment, the energy absorption structure comprises a bushing assembly, the bushing assembly comprises an inner bushing and an outer bushing mating with each other, the inner bushing sleeves the pen tip shaft, and the outer bushing is fixed to the holding structure.

As can be seen from the above description, the bushing assembly is simple and practical in structure and good in working stability.

In a specific embodiment, the bushing assembly comprises two outer bushings, the outer bushing comprises an annular portion having an inner curved surface, the inner bushing is provided with an outer circumferential wall having an outer curved surface matching with the inner curved surface, and the annular portions of the two outer bushings are close to each other to form a limiting cavity for limiting the position of the inner bushing.

As can be seen from the above description, the bushing assembly is structurally stable, and the inner bushing will not accidentally disengage from the outer bushing.

In a specific embodiment, the two outer bushings of the bushing assembly are fixedly connected with each other.

As can be seen from the above description, the bushing assembly is an integrated structure, facilitating the assembly and manufacture of the pen tip assembly.

In a specific embodiment, the outer bushing further comprises an extended portion, the extended portion is on the outer side of the annular portion and connected to the annular portion, and the outer bushing is fixed to the holding structure via the extended portion.

As can be seen from the above description, the extended portion not only facilitates the molding of the outer bushing, but also facilitates the connection and fixing of the outer bushing and the holding structure.

In a specific embodiment, the inner bushing sleeves a middle region of the pen tip shaft.

In a specific embodiment, the pen tip shaft is provided with a mounting column is at the tail end, and the inner bushing is sleeves the mounting column.

As can be seen from the above description, the mounting position the bushing structure may be set according to the needs, which is beneficial to enrich the structural diversity of the capacitive stylus pen. In addition, when the inner bushing sleeves the middle region of the pen tip shaft, the occupied space of the pen tip assembly in the length direction can be reduced, and the internal structure of the capacitive stylus pen is more compact. As the pen tip shaft is provided with the mounting column is at the tail end, the mounting of the bushing assembly on the pen tip shaft can be facilitated.

In a specific embodiment, the energy absorption structure comprises a resilient support.

As can be seen from the above description, the resilient support as the energy absorption structure is easy to manufacture and has a good energy-absorbing effect.

In a specific embodiment, the resilient support comprises a fixing portion and a plurality of resilient branch portions provided on the fixing portion, the fixing portion is fixedly connected to the pen tip shaft, and the resilient branch portions are fixedly connected to the holding structure.

As can be seen from the above description, the resilient support is simple and stable in structure and can provide a sufficient buffer.

In a specific embodiment, the plurality of resilient branch portions are uniformly distributed along the periphery of the fixing portion.

As can be seen from the above description, the plurality of resilient branch portions are uniformly distributed, so that the pen tip shaft may receive a more balanced buffer, and the monitoring accuracy of the strain sensor is favorably improved.

In a specific embodiment, the resilient support further comprises reinforcing spokes, and every two adjacent resilient branch portions are connected through the reinforcing spokes.

As can be seen from the above description, the structural strength of the resilient support can be improved by with the reinforcing spokes, and the reinforcing spokes can be effectively prevented from being irreversibly deformed in operation; meanwhile, with the reinforcing spokes, the elastic modulus of the resilient support can be improved, so that the buffering effect of the resilient support is improved, and the stress borne by the strain sensor is further shared; in addition, the connection between the resilient branch portions and the holding structure is also facilitated with the reinforcing spokes, and the resilient branch portions are prevented from shaking freely when the resilient branch portions are connected to the holding structure.

In a specific embodiment, the energy absorption structure comprises an elastic piece and a fixing piece, the fixing piece is fixed to the holding structure, and the elastic piece is connected to both the fixing piece and the pen tip shaft.

As can be seen from the above description, the energy absorption structure is simple in structure, easy to manufacture and good in working stability.

In a specific embodiment, the fixing piece comprises a fixing plate and a limiting structure provided on the fixing plate.

As can be seen from the above description, the limiting structure is provided to limit the position of the elastic piece, facilitating the assembly of the elastic piece.

In a specific embodiment, the elastic piece is a spring, and one end of the spring cooperates with the limiting structure.

As can be seen from the above description, the limiting structure can prevent deviation of the elastic piece, ensuring the structural stability of the capacitive stylus pen.

In a specific embodiment, the limiting structure is annular or columnar.

As can be seen from the above description, the limiting structure is simple in structure and easy to form.

### Embodiment 1

Referring to FIGS. 1 to 17, Embodiment 1 of the present application provides a capacitive stylus pen, which is appliable for touch control operation of touch control devices, such as mobile phones, tablet computers, navigators, etc.

Referring to FIGS. 1 to 3, the capacitive stylus pen comprises a holding structure, the holding structure comprises a pen holder 1, a pen tip assembly 2, a chip module 3, a main control board 4, a battery 5 and an antenna module 6 are provided in the pen holder 1, the antenna module 6, the chip module 3 and the battery 5 are electrically connected to the main control board 4, and the pen tip assembly 2 is located at the head of the pen holder 1. In this embodiment, the holding structure further comprises a pen support 7 and a shielding assembly 8, the pen support 7 and the shielding assembly 8 are arranged within the pen holder 1, the pen support 7 is connected to the pen tip assembly 2, the shielding assembly 8 covers the pen tip assembly 2 to shield the pen tip assembly 2, and the antenna module 6. the main control board 4 and the battery 5 are fixed to the pen support 7. Specifically, the pen tip assembly 2 is connected and fixed to the pen support 7 via the shielding assembly 8. It should be noted that, in other embodiments, the holding structure may not be provided with the pen support 7 and/or the shielding assembly 8, in which case the pen tip assembly 2, the antenna module 6, the main control board 4 and the battery 5 are directly fixed to the pen holder 1. Alternatively, the pen support 7 is a metal injection molded structural component, so that the design and manufacture of the pen support 7 are facilitated.

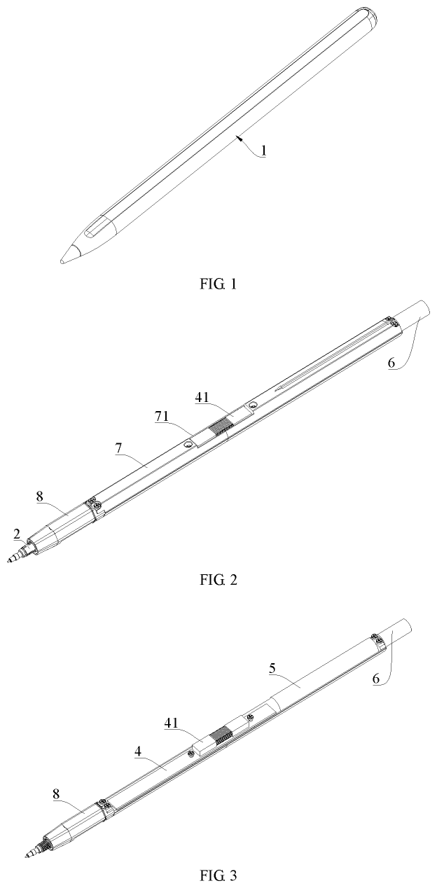

Referring to FIGS. 2 and 3, in order to facilitate charging, the main control board 4 is provided with a wireless charging module 41, the wireless charging module 41 is electrically connected with the main control board 4, and the pen support 7 is provided with a window 71 corresponding to the wireless charging module 41.

Referring to FIGS. 4 to 6, specifically, the pen tip assembly 2 comprises a pen tip shaft 21, an electrode assembly 22 and a strain sensor 23, the electrode assembly 22 is electrically connected to the chip module 3, the strain sensor 23 comprises a resilient element 231 and a strain gauge 232 on the resilient element 231, the resilient element 231 is L-shaped, and the resilient element 231 is connected and fixed to the pen tip shaft 21 and the holding structure. In this embodiment, the pen tip assembly 2 further comprises an energy absorption structure sleeving a middle region of the pen tip shaft 21, and the energy absorption structure is connected to the holding structure.

More specifically, the resilient element 231 comprises a first arm 2311 and a second arm 2312 which are connected, the first arm 2311 is connected and fixed to the holding structure, the second arm 2312 is fixed to the pen tip shaft 21, and the strain gauge 232 is arranged on the first arm 2311. Preferably, the pen tip shaft 21 comprises a flat plate part 211, the second arm 2312 is fixed on the flat plate part 211, and the flat plate part 211 is provided with limiting ribs 2111 for limiting the position of the second arm 2312; and there are two limiting ribs 2111, and the second arm 2312 is located between the two limiting ribs 2111. As a preferred embodiment, the terminal, at one end, away from the second arm 2312, of the first arm 2311 is fixed to the holding structure, so that the assembly of the capacitive stylus pen is facilitated with materials saved, and the reaction sensitivity of the strain gauge 232 can be ensured.

As shown in FIG. 4, in order to further secure the sensitivity of the strain sensor 23, preferably, the first arm 2311 is disposed close to one end, away from the electrode assembly 22, of the pen tip shaft 21, that is, a sufficient distance remains between the first arm 2311 and the energy absorption structure.

In detail, the first arm 2311 is fixed by welding to the shielding assembly 8, and the second arm 2312 is fixed by welding to the flat plate part 211. In other embodiments, the first arm 2311 may also be directly fixed to the pen support 7 or the pen holder 1, in particular by fixing means such as screwing, gluing, snapping, or the like; and the second arm 2312 may also be connected and fixed to the pen tip shaft 21 by fixing means such as screwing, gluing, snapping, or the like. Referring to FIGS. 4 and 5, in order to make the internal structure of the capacitive stylus pen more compact and shorten the conduction distance between the electrode assembly 22 and the chip module 3, preferably, the chip module 3 is provided on the flat plate part 211, and the chip module 3 is electrically connected to the strain gauge 232 and the electrode assembly 22. More preferably, the chip module 3 is fixed on the limiting ribs 2111, so that the limiting ribs 2111 not only limit and protect the second arm 2312, but also provides a mounting position for the chip module 3, so that multiple purposes are achieved by one component.

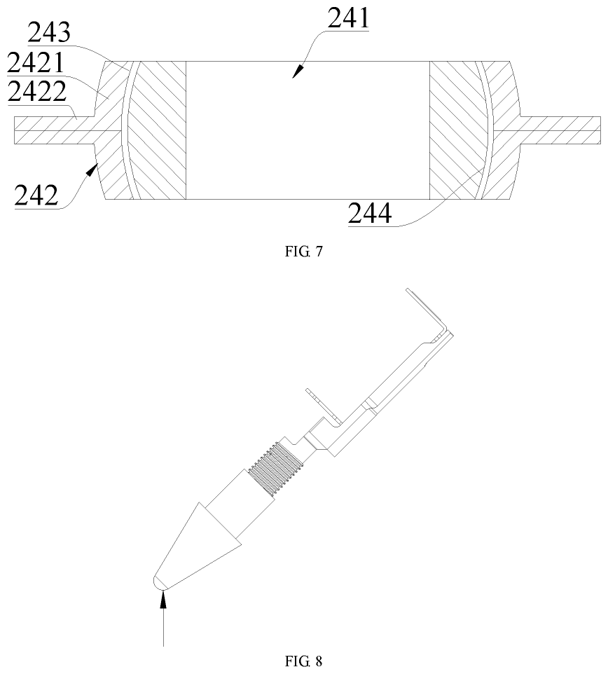

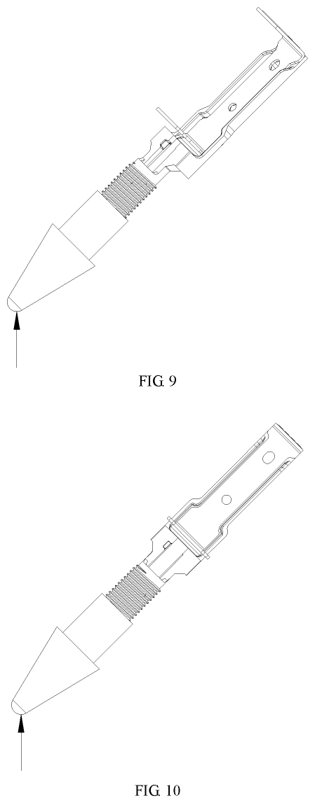

Referring to FIGS. 5 and 7, in this embodiment, the energy absorption structure comprises a bushing assembly 24, the bushing assembly 24 comprises an inner bushing 241 and an outer bushing 242 mating with each other, the inner bushing 241 sleeves a middle region of the pen tip shaft 21, and the outer bushing 242 is fixed to the holding structure. In detail, the bushing assembly 24 comprises two outer bushings 242, the outer bushing 242 comprises an annular portion 2421 having an inner curved surface 243, the inner bushing 241 is provided with an outer circumferential wall having an outer curved surface 244 matching with the inner curved surface 243, and the annular portions 2421 of the two outer bushings 242 are close to each other to form a limiting cavity for limiting the position of the inner bushing 241. The diameter of the two openings of the limiting cavity is smaller than the maximum diameter of the outer curved surface 244, so that the inner bushing 241 is prevented from disengaging from the limiting cavity, ensuing the structural stability of the bushing assembly 24.

Preferably, the two outer bushings 242 of the bushing assembly 24 are fixedly connected with each other. In this embodiment, the outer bushing 242 further comprises an extended portion 2422, the extended portion 2422 is on the outer side of the annular portion 2421 and connected to the annular portion 2421, and the outer bushing 242 is fixed to the holding structure via the extended portion 2422. Specifically, the two extended portions 2422 of the bushing assembly 24 are fixed by welding, although it is also possible for the two outer bushings 242 to be connected by other fixing means, such as screwing, snapping, gluing, etc.

Referring to FIGS. 4 and 5, the pen tip shaft 21 is further provided with a threaded section 212 and a connecting press piece 25 to press against the electrode assembly 22, the threaded section 212 is threadedly connected to a pen tip locking piece 26, and the pen tip locking piece 26 presses against the connecting press piece 25 to lock the electrode assembly 22. When the pen tip locking piece 26 locks with the connecting press piece 25, at least a part of the connecting press piece 25 is located within the pen tip locking piece 26, thereby forming a press.

The inner bushing 241 is in interference fit with the pen tip shaft 21, and in order to ensure the structural stability of the pen tip assembly 2, the pen tip shaft 21 is provided with an abutting step 213, and two ends of the inner bushing 241 abut against the abutting step 213 and the pen tip locking piece 26, respectively, so that the inner bushing 241 and the pen tip shaft 21 are stably connected and fixed. Accordingly, in this embodiment, the pen tip locking piece 26 functions both to lock the connecting press plate and to lock the inner bushing 241, thereby achieving a multi-purpose use. Of course, the inner bushing 241 and the pen tip shaft 21 may be fixedly connected or secured by bonding, snapping, or the like.

In order to ensure the structural stability of the outer bushing 242 and facilitate its manufacture, the annular portion 2421 and the extended portion 2422 may be a one-piece structure formed by stretching a piece of sheet metal.

Simulation Test

In order to further illustrate the advantages of the technical scheme of the present application, the applicant carried out simulation tests on a capacitive stylus pen (the resilient element is U-shaped) in the prior art and the capacitive stylus pen provided by this embodiment.

TABLE 1
Simulation test results for capacitive stylus
pen with U-shaped resilient element

| | Tilt angle | | | | | |
|---|---|---|---|---|---|---|
| | of pen | | Self-ration of | Deformation of | Stress on | |
| | holder | Force | pen holder | strain gauge | strain gauge | |
| 1 | 45° | 400N | 0° | 0.015573 mm | 81.51 | MPa |
| 2 | 45° | 400N | 45° | 0.015861 mm | 111.45 | MPa |
| 3 | 45° | 400N | 90° | 0.0161893 mm | 152 | MPa |
| 4 | 45° | 400N | 135° | 0.016276 mm | 147.48 | MPa |
| 5 | 45° | 400N | 180° | 0.016068 mm | 119.31 | MPa |

From the calculation results in Table 1, it can be seen that the deformation rate σ of the stress sensor in the capacitive stylus pen with the U-shaped resilient element: |Max−Min|/Max=4.319%. The states of the capacitive stylus pen in Table 1 may refer to FIGS. 8 to 12.

TABLE 2
Simulation test results of capacitive
stylus pen provided by this embodiment

| | Tilt angle | | | | |
|---|---|---|---|---|---|
| | of pen | | Self-ration of | Deformation of | Stress on |
| | holder | Force | pen holder | strain gauge | strain gauge |
| 1 | 45° | 400N | 0° | 0.031945 mm | 205.48 MPa |
| 2 | 45° | 400N | 45° | 0.031905 mm | 206.14 MPa |
| 3 | 45° | 400N | 90° | 0.031765 mm | 206.37 MPa |
| 4 | 45° | 400N | 135° | 0.031604 mm | 205.41 MPa |
| 5 | 45° | 400N | 180° | 0.031518 mm | 204.42 MPa |

From the calculation results in Table 2, it can be seen that the deformation rate σ of the stress sensor in the capacitive stylus pen provided by this embodiment: |Max−Min|/Max=1.3367%. The states of the capacitive stylus pen in Table 2 may refer to FIGS. 13 to 17.

As can be seen from above, the deformation rate σ of the stress sensor in the capacitive stylus pen provided by this embodiment is much smaller than the deformation rate of the stress sensor in the capacitive stylus pen of the prior art, which proves that the capacitive stylus pen of this embodiment is superior in signal output uniformity performance compared with the capacitive stylus pen of the prior art. In addition, the stress on the stress sensor in the capacitive stylus pen provided by this embodiment is generally larger than the stress on the stress sensor in the capacitive stylus pen of the prior art, so that the capacitive stylus pen of this embodiment has the advantage of clear signal output.

### Embodiment 2

Referring to FIGS. 1 to 3, 18, and 19, Embodiment 2 of the present application provides a capacitive stylus pen, which is appliable for touch control operation of touch control devices, such as mobile phones, tablet computers, navigators, etc.

Referring to FIGS. 1 to 3, the capacitive stylus pen comprises a holding structure, the holding structure comprises a pen holder 1, a pen tip assembly 2, a chip module (not shown), a main control board 4, a battery 5 and an antenna module 6 are provided in the pen holder 1, the antenna module 6, the chip module and the battery 5 are electrically connected to the main control board 4, and the pen tip assembly 2 is located at the head of the pen holder 1. In this embodiment, the holding structure further comprises a pen support 7 and a shielding assembly 8, the pen support 7 and the shielding assembly 8 are arranged within the pen holder 1, the pen support 7 is connected to the pen tip assembly 2, the shielding assembly 8 covers the pen tip assembly 2 to shield the pen tip assembly 2, and the antenna module 6. the main control board 4 and the battery 5 are fixed to the pen support 7. Specifically, the pen tip assembly 2 is connected and fixed to the pen support 7 via the shielding assembly 8. It should be noted that, in other embodiments, the holding structure may not be provided with the pen support 7 and/or the shielding assembly 8, in which case the pen tip assembly 2, the antenna module 6, the main control board 4 and the battery 5 are directly fixed to the pen holder 1. Alternatively, the pen support 7 is a metal injection molded structural component, so that the design and manufacture of the pen support 7 are facilitated.

In order to facilitate charging, the main control board 4 is provided with a wireless charging module 41, the wireless charging module 41 is electrically connected with the main control board 4, and the pen support 7 is provided with a window 71 corresponding to the wireless charging module 41.

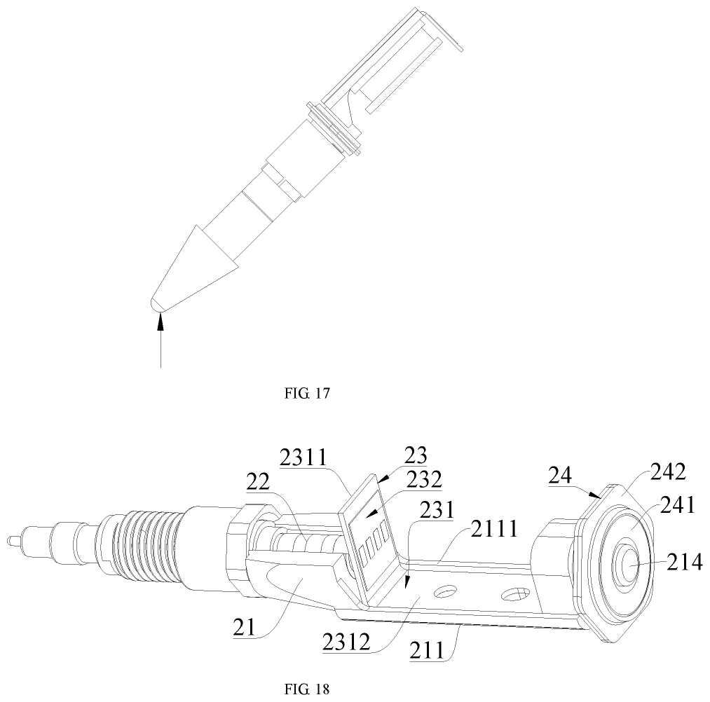

Referring to FIG. 18, specifically, the pen tip assembly 2 comprises a pen tip shaft 21, an electrode assembly 22 and a strain sensor 23, the electrode assembly 22 is electrically connected to the chip module, the strain sensor 23 comprises a resilient element 231 and a strain gauge 232 on the resilient element 231, the resilient element 231 is L-shaped, and the resilient element 231 is connected and fixed to the pen tip shaft 21 and the holding structure. The pen tip assembly 2 further comprises a mounting column 214 provided on the pen tip shaft 21, and an energy absorption structure arranged on the mounting column 214, and the energy absorption structure is connected to the holding structure.

More specifically, the resilient element 231 comprises a first arm 2311 and a second arm 2312 which are connected, the first arm 2311 is connected and fixed to the holding structure, the second arm 2312 is fixed to the pen tip shaft 21, and the strain gauge 232 is arranged on the first arm 2311. Preferably, the pen tip shaft 21 comprises a flat plate part 211, the second arm 2312 is fixed on the flat plate part 211, and the flat plate part 211 is provided with limiting ribs 2111 for limiting the position of the second arm 2312; and there are two limiting ribs 2111, and the second arm 2312 is located between the two limiting ribs 2111. As a preferred embodiment, the terminal, at one end, away from the second arm 2312, of the first arm 2311 is fixed to the holding structure, so that the assembly of the capacitive stylus pen is facilitated with materials saved, and the reaction sensitivity of the strain gauge 232 can be ensured.

In order to further secure the sensitivity of the strain sensor 23, preferably, the mounting column 214 is disposed at one end, away from the electrode assembly 22, of the pen tip shaft 21, and the first arm 2311 is arranged far away from the mounting column 214, that is, a sufficient distance remains between the first arm 2311 and the energy absorption structure.

In detail, the first arm 2311 is fixed by welding to the shielding assembly 8, the second arm 2312 is fixed by welding to the flat plate part 211, and the energy absorption structure is fixed by welding to the shielding assembly 8. In other embodiments, the first arm 2311 may also be directly fixed to the pen support 7 or the pen holder 1, in particular by fixing means such as screwing, gluing, snapping, or the like; the energy absorption structure may also be directly fixed to the pen support 7 or the pen holder 1, in particular by fixing means such as screwing, gluing, snapping, or the like; and the second arm 2312 may also be connected and fixed to the pen tip shaft 21 by fixing means such as screwing, gluing, snapping, or the like.

In order to make the internal structure of the capacitive stylus pen more compact and shorten the conduction distance between the electrode assembly 22 and the chip module, preferably, the chip module is provided on the flat plate part 211, and the chip module is electrically connected to the strain gauge 232 and the electrode assembly 22. More preferably, the chip module is fixed on the limiting ribs 2111, so that the limiting ribs 2111 not only limit and protect the second arm 2312, but also provides a mounting position for the chip module, so that multiple purposes are achieved by one component.

Referring to FIGS. 18 and 19, in this embodiment, the energy absorption structure comprises a bushing assembly 24, the bushing assembly 24 comprises an inner bushing 241 and an outer bushing 242 mating with each other, the inner bushing 241 sleeves the mounting column 214, and the outer bushing 242 is fixed to the holding structure. In detail, the bushing assembly 24 comprises two outer bushings 242, the outer bushing 242 comprises an annular portion 2421 having an inner curved surface 243, the inner bushing 241 is provided with an outer circumferential wall having an outer curved surface 244 matching with the inner curved surface 243, and the annular portions 2421 of the two outer bushings 242 are close to each other to form a limiting cavity for limiting the position of the inner bushing 241. The diameter of the two openings of the limiting cavity is smaller than the maximum diameter of the outer curved surface 244, so that the inner bushing 241 is prevented from disengaging from the limiting cavity, ensuing the structural stability of the bushing assembly 24.

As shown in FIG. 19, preferably, the two outer bushings 242 of the bushing assembly 24 are fixedly connected with each other. In this embodiment, the outer bushing 242 further comprises an extended portion 2422, the extended portion 2422 is on the outer side of the annular portion 2421 and connected to the annular portion 2421, and the outer bushing 242 is fixed to the holding structure via the extended portion 2422. Specifically, the two extended portions 2422 of the bushing assembly 24 are fixed by welding, and the inner bushing 241 is fixed by welding to the mounting column 214, although it is also possible for the two outer bushings 242 to be connected by other fixing means, such as screwing, snapping, gluing, etc.; and similarly, it is also possible for the inner bushing 241 to be connected to the mounting column 214 by other fixing means, such as screwing, snapping, gluing, etc.

As a preferred embodiment, the inner bushing 241 is provided with a mounting hole matching the mounting column 214, two ends of the mounting hole are each provided with a chamfer structure 245, and when the inner bushing 241 is mounted on the mounting column 214, the chamfer structures 245 can provide guidance to facilitate the mounting of the inner bushing 241; in welding of the inner bushing 241 to the mounting column 214, the chamfer structures 245 can function as a tin-containing feature, thereby improving the stability of the connection of the inner bushing 241 to the mounting column 214. As can be seen, the chamfered structures 245 also achieves a multi-purpose use in this embodiment.

In order to ensure the structural stability of the outer bushing 242 and facilitate its manufacture, the annular portion 2421 and the extended portion 2422 may be a one-piece structure formed by stretching a piece of sheet metal.

### Embodiment 3

Referring to FIGS. 1 to 3, 20, and 21, Embodiment 3 of the present application provides a capacitive stylus pen, which is appliable for touch control operation of touch control devices, such as mobile phones, tablet computers, navigators, etc.

Referring to FIGS. 1 to 3, the capacitive stylus pen comprises a holding structure, the holding structure comprises a pen holder 1, a pen tip assembly 2, a chip module (not shown), a main control board 4, a battery 5 and an antenna module 6 are provided in the pen holder 1, the antenna module 6, the chip module and the battery 5 are electrically connected to the main control board 4, and the pen tip assembly 2 is located at the head of the pen holder 1. In this embodiment, the holding structure further comprises a pen support 7 and a shielding assembly 8, the pen support 7 and the shielding assembly 8 are arranged within the pen holder 1, the pen support 7 is connected to the pen tip assembly 2, the shielding assembly 8 covers the pen tip assembly 2 to shield the pen tip assembly 2, and the antenna module 6. the main control board 4 and the battery 5 are fixed to the pen support 7. Specifically, the pen tip assembly 2 is connected and fixed to the pen support 7 via the shielding assembly 8. It should be noted that, in other embodiments, the holding structure may not be provided with the pen support 7 and/or the shielding assembly 8, in which case the pen tip assembly 2, the antenna module 6, the main control board 4 and the battery 5 are directly fixed to the pen holder 1. Alternatively, the pen support 7 is a metal injection molded structural component, so that the design and manufacture of the pen support 7 are facilitated.

In order to facilitate charging, the main control board 4 is provided with a wireless charging module 41, the wireless charging module 41 is electrically connected with the main control board 4, and the pen support 7 is provided with a window 71 corresponding to the wireless charging module 41.

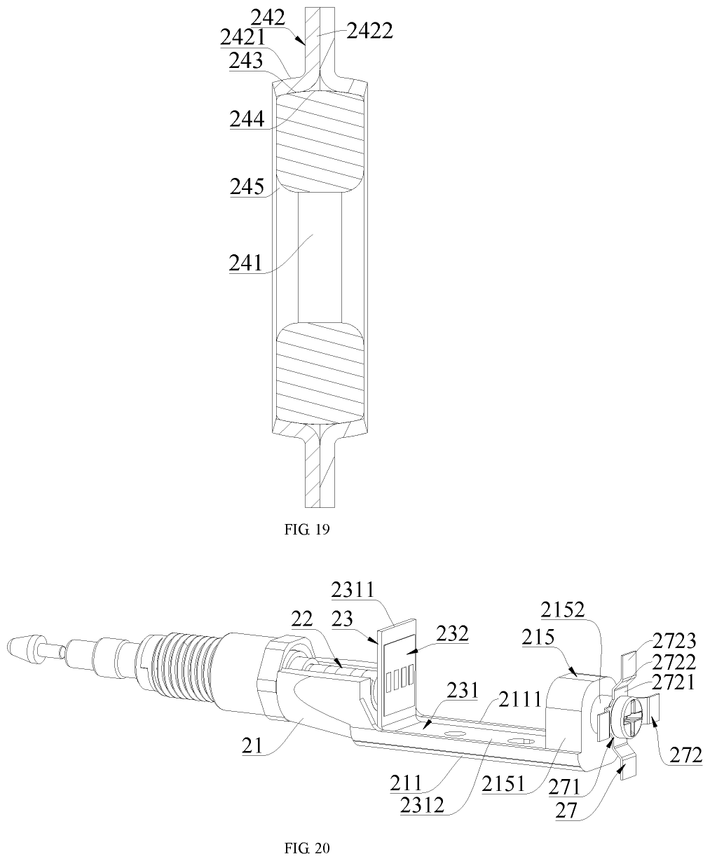

Referring to FIG. 20, specifically, the pen tip assembly 2 comprises a pen tip shaft 21, an electrode assembly 22 and a strain sensor 23, the electrode assembly 22 is electrically connected to the chip module, the strain sensor 23 comprises a resilient element 231 and a strain gauge 232 on the resilient element 231, the resilient element 231 is L-shaped, and the resilient element 231 is connected and fixed to the pen tip shaft 21 and the holding structure. The pen tip assembly further comprises an energy absorption structure 21 arranged on the pen tip shaft, and the energy absorption structure is connected to the holding structure. In this embodiment, the energy absorption structure comprises a resilient support 27.

More specifically, the resilient element 231 comprises a first arm 2311 and a second arm 2312 which are connected, the first arm 2311 is connected and fixed to the holding structure, the second arm 2312 is fixed to the pen tip shaft 21, and the strain gauge 232 is arranged on the first arm 2311. Preferably, the pen tip shaft 21 comprises a flat plate part 211, the second arm 2312 is fixed on the flat plate part 211, and the flat plate part 211 is provided with limiting ribs 2111 for limiting the position of the second arm 2312; and there are two limiting ribs 2111, and the second arm 2312 is located between the two limiting ribs 2111. As a preferred embodiment, the terminal, at one end, away from the second arm 2312, of the first arm 2311 is fixed to the holding structure, so that the assembly of the capacitive stylus pen is facilitated with materials saved, and the reaction sensitivity of the strain gauge 232 can be ensured.

In order to make the internal structure of the capacitive stylus pen more compact and shorten the conduction distance between the electrode assembly 22 and the chip module, preferably, the chip module is provided on the flat plate part 211, and the chip module is electrically connected to the strain gauge 232 and the electrode assembly 22. More preferably, the chip module is fixed on the limiting ribs 2111, so that the limiting ribs 2111 not only limit and protect the second arm 2312, but also provides a mounting position for the chip module, so that multiple purposes are achieved by one component.

In detail, the first arm 2311 is fixed by welding to the shielding assembly 8, the second arm 2312 is fixed by welding to the flat plate part 211, and the resilient support 27 is fixed by welding to the shielding assembly 8. In other embodiments, the first arm 2311 may also be directly fixed to the pen support 7 or the pen holder 1, in particular by fixing means such as screwing, gluing, snapping, or the like; the resilient support 27 may also be directly fixed to the pen support 7 or the pen holder 1, in particular by fixing means such as screwing, gluing, snapping, or the like; and the second arm 2312 may also be connected and fixed to the pen tip shaft 21 by fixing means such as screwing, gluing, snapping, or the like.

As shown in FIG. 20, in order to further secure the sensitivity of the strain sensor 23, a mounting part 215 is disposed at one end, away from the electrode assembly 22, of the pen tip shaft 21, the resilient support 27 is mounted on the mounting part 215, and the first arm 2311 is arranged far away from the mounting part 215, that is, the first arm 2311 is arranged far away from the resilient support 27. In this manner, a sufficient distance remains between the first arm 2311 and the resilient support 27. In this embodiment, the mounting part 215 comprises a mounting plate portion 2151 connected to the pen tip shaft 21 and a post 2152 provided on the mounting plate portion 2151, the post 2152 further increases the distance between the first arm 2311 and the resilient support 27, and the resilient support 27 is fixed to the post 2152 by screws. As a preferred embodiment, the pen tip shaft 21 and the mounting portion 215 are a one-piece formed structure. In this embodiment, the resilient support 27 comprises a fixing portion 271 and a plurality of resilient branch portions 272 provided on the periphery of the fixing portion 271, the fixing portion 271 is fixedly connected to the pen tip shaft 21, the resilient branch portions 272 are fixedly connected to the holding structure, and the fixing portion 271 is provided with through holes for screws to pass through.

In order to ensure that the resilient support 27 can provide a balanced buffer, the plurality of the resilient branch portions 272 are uniformly arranged along the periphery of the fixing portion 271. In this embodiment, there are four resilient branch portions 272, and two adjacent resilient branch portions 272 are arranged at an interval of 90°. In other embodiments, the number of the resilient branch portions 272 may also be two, three, five, six, etc.

As illustrated in this embodiment, the resilient branch portions 272 are generally Z-shaped, and specifically, the resilient branch portions 272 include a first moment arm 2721, a tilt moment arm 2722 and a second moment arm 2723 which are sequentially connected, where one end of the first moment arm 2721 is connected to the fixing portion 271, the other end of the first moment arm 2721 is bent and extended obliquely upward away from the fixing portion 271 to form the tilt moment arm 2722, one end of the tilt arm far away from the first moment arm 2721 is bent and extended outwardly to form the second moment arm 2723, and one end of the second moment arm 2723 far away from the tilt arm 2722 is fixedly connected to the holding structure. Alternatively, the second moment arm 2723 is parallel to the first moment arm 2721. In other embodiments, the particular configuration of the resilient branch portions 272 may be of other shapes, such as arcuate, helical, etc., and when the resilient branch portions 272 are helical, the plurality of resilient branch portions 272 form a swirl pattern

As a preferred embodiment, the resilient support 27 is a one-piece structure formed by cutting and bending a piece of sheet metal.

Of course, in other embodiments, the resilient support 27 may be of other configurations, such as springs, rubber members, etc.

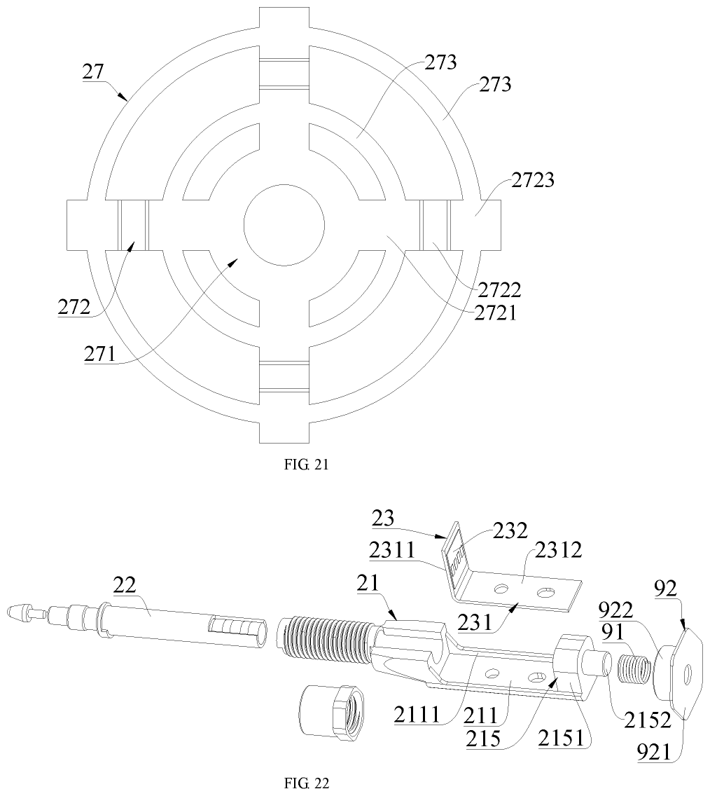

As shown in FIG. 21, more preferably, alternatively, the resilient support 27 further comprises reinforcing spokes 273, and every two adjacent resilient branch portions 272 are connected through the reinforcing spokes 273. At this time, when the resilient support 27 is viewed from the top, the resilient support 27 may be cobweb shaped. With the reinforcing spokes 273, the structural stability of the resilient support 27 and its elastic modulus can be improved, and the assembly of the capacitive stylus pen is facilitated.

### Embodiment 4

Referring to FIGS. 1 to 3, and 22, Embodiment 4 of the present application provides a capacitive stylus pen, which is appliable for touch control operation of touch control devices, such as mobile phones, tablet computers, navigators, etc.

Referring to FIGS. 1 to 3, the capacitive stylus pen comprises a holding structure, the holding structure comprises a pen holder 1, a pen tip assembly 2, a chip module (not shown), a main control board 4, a battery 5 and an antenna module 6 are provided in the pen holder 1, the antenna module 6, the chip module and the battery 5 are electrically connected to the main control board 4, and the pen tip assembly 2 is located at the head of the pen holder 1. In this embodiment, the holding structure further comprises a pen support 7 and a shielding assembly 8, the pen support 7 and the shielding assembly 8 are arranged within the pen holder 1, the pen support 7 is connected to the pen tip assembly 2, the shielding assembly 8 covers the pen tip assembly 2 to shield the pen tip assembly 2, and the antenna module 6. the main control board 4 and the battery 5 are fixed to the pen support 7. Specifically, the pen tip assembly 2 is connected and fixed to the pen support 7 via the shielding assembly 8. It should be noted that, in other embodiments, the holding structure may not be provided with the pen support 7 and/or the shielding assembly 8, in which case the pen tip assembly 2, the antenna module 6, the main control board 4 and the battery 5 are directly fixed to the pen holder 1. Alternatively, the pen support 7 is a metal injection molded structural component, so that the design and manufacture of the pen support 7 are facilitated.

In order to facilitate charging, the main control board 4 is provided with a wireless charging module, the wireless charging module is electrically connected with the main control board 4, and the pen support 7 is provided with a window 71 corresponding to the wireless charging module. Referring to FIG. 22, specifically, the pen tip assembly 2 comprises a pen tip shaft 21, an electrode assembly 22 and a strain sensor 23, the electrode assembly 22 is electrically connected to the chip module, the strain sensor 23 comprises a resilient element 231 and a strain gauge 232 on the resilient element 231, the resilient element 231 is L-shaped, and the resilient element 231 is connected and fixed to the pen tip shaft 21 and the holding structure. The pen tip assembly 2 further comprises an energy absorption structure 21 arranged on the pen tip shaft 21, and the energy absorption structure is connected to the holding structure. In this embodiment, the energy absorption structure comprises an elastic piece 91 and a fixing piece 92, the fixing piece 92 is fixed to the holding structure, and the elastic piece 91 is connected to both the fixing piece 92 and the pen tip shaft 21.

More specifically, the resilient element 231 comprises a first arm 2311 and a second arm 2312 which are connected, the first arm 2311 is connected and fixed to the holding structure, the second arm 2312 is fixed to the pen tip shaft 21, and the strain gauge 232 is arranged on the first arm 2311.

Preferably, the pen tip shaft 21 comprises a flat plate part 211, the second arm 2312 is fixed on the flat plate part 211, and the flat plate part 211 is provided with limiting ribs 2111 for limiting the position of the second arm 2312; and there are two limiting ribs 2111, and the second arm 2312 is located between the two limiting ribs 2111. As a preferred embodiment, the terminal, at one end, away from the second arm 2312, of the first arm 2311 is fixed to the holding structure, so that the assembly of the capacitive stylus pen is facilitated with materials saved, and the reaction sensitivity of the strain gauge 232 can be ensured.

In order to make the internal structure of the capacitive stylus pen more compact and shorten the conduction distance between the electrode assembly 22 and the chip module, preferably, the chip module is provided on the flat plate part 211, and the chip module is electrically connected to the strain gauge 232 and the electrode assembly 22. More preferably, the chip module is fixed on the limiting ribs 2111, so that the limiting ribs 2111 not only limit and protect the second arm 2312, but also provides a mounting position for the chip module, so that multiple purposes are achieved by one component.

In detail, the first arm 2311 is fixed by welding to the shielding assembly 8, the second arm 2312 is fixed by welding to the flat plate part 211, and the fixing piece 92 is fixed by welding to the shielding assembly 8. In other embodiments, the first arm 2311 may also be directly fixed to the pen support 7 or the pen holder 1, in particular by fixing means such as screwing, gluing, snapping, or the like; the fixing piece 92 may also be directly fixed to the pen support 7 or the pen holder 1, in particular by fixing means such as screwing, gluing, snapping, or the like; and the second arm 2312 may also be connected and fixed to the pen tip shaft 21 by fixing means such as screwing, gluing, snapping, or the like.

In order to further secure the sensitivity of the strain sensor 23, a mounting part 215 is disposed at one end, away from the electrode assembly 22, of the pen tip shaft 21, the elastic piece 91 is mounted on the mounting part 215, and the first arm 2311 is arranged far away from the mounting part 215, that is, the first arm 2311 is arranged far away from the elastic piece 91. In this manner, a sufficient distance remains between the first arm 2311 and the elastic piece 91.

In this embodiment, the elastic piece 91 is a spring, and the mounting part 215 comprises a mounting plate portion 2151 connected to the pen tip shaft 21 and a post 2152 provided on the mounting plate portion 2151, and one end of the spring sleeves the post 2152. As a preferred embodiment, the pen tip shaft 21 and the mounting portion 215 are a one-piece formed structure. In other embodiments, the elastic piece 91 may be of other configurations, such as X-shaped flat springs, V-shaped flat springs, rubber members, etc.

The fixing piece 92 comprises a fixing plate 921 and a limiting structure 922 arranged on the fixing plate 921, and one end of the spring cooperates with the limiting structure 922. In this embodiment, the limiting structure 922 has a ring shape, and at this time, the other end of the spring is sheathed in the limiting structure 922 and presses against the fixing plate 921. Therefore, it can be seen that the outer diameter of the post 2152 is smaller than the inner diameter of the spring, and the outer diameter of the spring is smaller than the inner diameter of the limiting structure 922, so that the axial length space occupied by the pen tip assembly 2 in the capacitive stylus pen can be effectively reduced, and more space can be provided for other components in the capacitive stylus pen. Of course, in other embodiments, it is also possible that the limiting structure 922 is columnar.

In summary, in the capacitive stylus pen provided by the present application, the L-shaped resilient element in cooperation with the energy absorption structure forms a double-support elastic buffering structure, which is novel and practical, and enables the capacitive stylus pen to rotate to different angles and also reduces deformation rate of the strain gauge with the same load, so that the signal output consistency is excellent, achieving the same use effect and experience as a U-shaped resilient element; compared with a single-arm resilient element, the energy absorption structure is added to share part of the stress on the resilient element so as to reduce the deformation of the resilient element, thereby prolonging the service life of the resilient element; In addition, under the conditions of different writing angles and inclination angles, the capacitive stylus pen has a good linear relation of strain, and has a great advantage in the subsequent design of chip selection. The energy absorption structure may be of different types, which greatly enriches the structural diversity of the capacitive stylus pen.

The above are only the embodiments of the present application, and are not intended to limit the scope of the application. All changes which come within the meaning and range of equivalency of the description and drawings, either directly or indirectly, are to be embraced within the scope of the application.

1. A capacitive stylus pen, comprising a holding structure comprising a pen holder, and a pen tip assembly comprising a pen tip shaft and a strain sensor, the strain sensor comprising a resilient element and a strain gauge on the resilient element, and the resilient element being connected to the pen tip shaft and the holding structure, wherein the resilient element is L-shaped, the pen tip assembly further comprises an energy absorption structure arranged on the pen tip shaft, and the energy absorption structure is connected to the holding structure.

2. The capacitive stylus pen of claim 1, wherein the resilient element comprises a first arm and a second arm which are connected, the first arm is connected and fixed to the holding structure, the second arm is fixed to the pen tip shaft, and the strain gauge is arranged on the first arm.

3. The capacitive stylus pen of claim 2, wherein the pen tip shaft comprises a flat plate part, the second arm is fixed on the flat plate part, and the flat plate part is provided with limiting ribs for limiting the position of the second arm.

4. The capacitive stylus pen of claim 3, wherein the pen tip assembly further comprises a chip module electrically connected to the strain sensor, and the chip module is arranged on the limiting ribs.

5. The capacitive stylus pen of claim 1, wherein the energy absorption structure is arranged far away from the strain gauge.

6. The capacitive stylus pen of claim 1, wherein the holding structure further comprises a pen support arranged in the pen holder and/or a shielding assembly arranged in the pen holder.

7. The capacitive stylus pen of claim 1, wherein the energy absorption structure comprises a bushing assembly, the bushing assembly comprises an inner bushing and an outer bushing mating with each other, the inner bushing sleeves the pen tip shaft, and the outer bushing is fixed to the holding structure.

8. The capacitive stylus pen of claim 7, wherein the bushing assembly comprises two outer bushings, the outer bushing comprises an annular portion having an inner curved surface, the inner bushing is provided with an outer circumferential wall having an outer curved surface matching with the inner curved surface, and the annular portions of the two outer bushings are close to each other to form a limiting cavity for limiting the position of the inner bushing.

9. The capacitive stylus pen of claim 8, wherein the two outer bushings of the bushing assembly are fixedly connected with each other.

10. The capacitive stylus pen of claim 8, wherein the outer bushing further comprises an extended portion, the extended portion is on the outer side of the annular portion and connected to the annular portion, and the outer bushing is fixed to the holding structure via the extended portion.

11. The capacitive stylus pen of claim 7, wherein the inner bushing sleeves a middle region of the pen tip shaft.

12. The capacitive stylus pen of claim 7, wherein the pen tip shaft is provided with a mounting column is at the tail end, and the inner bushing is sleeves the mounting column.

13. The capacitive stylus pen of claim 1, wherein the energy absorption structure comprises a resilient support.

14. The capacitive stylus pen of claim 13, wherein the resilient support comprises a fixing portion and a plurality of resilient branch portions provided on the fixing portion, the fixing portion is fixedly connected to the pen tip shaft, and the resilient branch portions are fixedly connected to the holding structure.

15. The capacitive stylus pen of claim 14, wherein the plurality of resilient branch portions are uniformly distributed along the periphery of the fixing portion.

16. The capacitive stylus pen of claim 14, wherein the resilient support further comprises reinforcing spokes, and every two adjacent resilient branch portions are connected through the reinforcing spokes.

17. The capacitive stylus pen of claim 1, wherein the energy absorption structure comprises an elastic piece and a fixing piece, the fixing piece is fixed to the holding structure, and the elastic piece is connected to both the fixing piece and the pen tip shaft.

18. The capacitive stylus pen of claim 17, wherein the fixing piece comprises a fixing plate and a limiting structure provided on the fixing plate.

19. The capacitive stylus pen of claim 18, wherein the elastic piece is a spring, and one end of the spring cooperates with the limiting structure.

20. The capacitive stylus pen of claim 19, wherein the limiting structure is annular or columnar.
